(19) United States
(12) Patent Application Publication
(10) Pub. No.: US 2005/0265352 A1
(43) Pub. Date: Dec. 1, 2005

(54) Recovery from MSS change

(76) Inventors: Giora Biran, Zichron-Yaakov (IL); Leah Shalev, Zichron-Yaakov (IL); Vadim Makhervaks, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/071,553

(22) Filed: Mar. 3, 2005

(30) Foreign Application Priority Data
Apr. 27, 2004 (GB) 0409331.6

(51) Int. Cl. H04L 12/56

(52) U.S. Cl. 370/395.52

(57) ABSTRACT

A method for performing Remote Direct Memory Access (RDMA), the method including creating Direct Data Placement (DDP) segments of data using a Maximum Segment Size (MSS), called the original MSS, using the DDP segments as a payload for TCP (Transport Control Protocol) segments, TCP transmitting data including the TCP segments, and if the original MSS has changed to a new MSS, temporarily halting DDP segmentation until outstanding data has been acknowledged.

### FIELD OF THE INVENTION

The present invention relates generally to methods for handling Maximum Segment Size (MSS) changes in the Remote Direct Memory Access (RDMA) protocol.

### BACKGROUND OF THE INVENTION

Remote Direct Memory Access (RDMA) is a technique for efficient movement of data over high-speed transports. RDMA enables a computer to directly place information (typically by means of Direct Data Placement (DDP) protocol) in another computer's memory with minimal demands on memory bus bandwidth and CPU processing overhead, while preserving memory protection semantics. It facilitates data movement via direct memory access by hardware, yielding faster transfers of data over a network while reducing host CPU overhead.

Different forms of RDMA are known and used (all of which are referred to herein as RDMA), such as but not limited to, VIA (Virtual Interface Architecture), InfiniBand and RDMAP (RDMA Protocol). In simplistic terms, VIA specifies RDMA capabilities without specifying underlying transport. InfiniBand specifies an underlying transport and a physical layer. RDMAP specifies an RDMA layer that interoperates over a standard TCP/IP (transport control protocol/Internet protocol) transport layer. A Remote Network Interface Controller (RNIC) provides support for the RDMA over TCP and can include a combination of TCP offload and RDMA functions in the same network adapter.

In order to understand the description that follows, some terms used in the RDMA and TCP protocols will now be defined.

Direct data placement refers to the process of writing segments to a data buffer. The direct data placement (DDP) segments carry (among other things) placement information, which may be used by the receiving DDP implementation to perform data placement of the DDP segment. Placement should not be confused with delivery. Data delivery is defined as the process of informing the consumer or upper layer protocol (ULP) that a particular message is available for use. This is different from placement, which may generally occur in any order, while the order of the delivery is strictly defined.

In a typical TCP operation, the TCP breaks the incoming application byte stream into segments. A segment is the unit of end-to-end transmission. A segment consists of a TCP header followed by application data. The Maximum Segment Size (MSS) is defined as the largest quantity of data that can be transmitted at one segment. The last data byte in each segment may be identified with a 32-bit byte count field in the segment header. Sequence numbers identify the last byte of data sent and received. When a segment is received correct and intact, acknowledgement is made thereof. The TCP header includes a field dedicated to acknowledgement called AckSN, and each TCP segment carries an updated AckSN (that is, updated to indicate whether the data was acknowledged or not).

The network service may fail to deliver a segment. If the sending TCP waits too long for an acknowledgment, it times out and resends the segment, on the assumption that the datagram has been lost. The network can potentially deliver duplicated segments, and can deliver segments out of order. TCP buffers or discards out of order or duplicated segments appropriately, using the byte count for identification. It is noted that there are other schemes that can be used for early detection of the lost packets, such as but not limited to, fast retransmit mode.

A cyclic redundancy check (CRC) is a type of check value designed to catch most transmission errors. The CRC may be calculated and checked per DDP segment. A decoder calculates the CRC for the received data and compares it to the CRC that the encoder calculated, which is appended to the data. A mismatch indicates that the data was corrupted.

Complications in RDMAP may occur due to changes in the MSS. The MSS can change due to different factors, such as modification of the network environment, addition or removal of routers on the way, or re-routing of the connection to another path.

Regardless of the reason for the MSS change, the Remote Network Interface Controller (RNIC) may be required to change the MSS of the given connection “on the fly”, that is, without connection termination. In straightforward TCP implementation without RDMA, the change of MSS is not problematic, since TCP operates with the byte-stream, and TCP is free to re-segment TCP segments both during transmit and retransmit, regardless of the previous MSS that was used for segmentation.

However, in RDMAP, the transmitter should align the DDP segments to fit the TCP segments. The standard also assumes that each DDP segment, besides the raw payload, has a DDP header, markers, padding, and CRC. DDP segments the DDP message into DDP segments, while preserving the DDP alignment property. During the transmit operation, the TCP re-segmentation breaks the alignment property of the generated DDP segments.

Two approaches have been used in the prior art to perform consistent retransmit operations. One approach is the use of retransmit buffers, which hold all generated DDP segments that were not acknowledged. The TCP layer keeps all the transmitted TCP segments as they were generated during the transmit operation, and uses the same TCP segments during the retransmit operation. This way the DDP segmentation used for the transmit operation is preserved, and no data coherency problems occur. However, this approach has drawbacks, such as a lack of scalability and the need for additional memory resources and memory bandwidth (for additional copies and storage of the segments for the retransmit operation).

Another option re-builds the DDP segments that need to be retransmitted. A drawback of the second option is that the transmitter must preserve the DDP segmentation which was made during the transmit operation, because re-segmentation may cause data coherency problems at the receiver. The transmitted DDP segments must be preserved during retransmit, even if the MSS was changed to a smaller size than that used for the originally transmitted DDP segments. Since the MSS change is not synchronized with the local RNIC and can result from changes in the network infrastructure, several MSS changes may happen sequentially one after another, thereby further complicating the RNIC transmitter implementation.

FIG. 1 illustrates an example of the second prior art approach.

DDP segments of data to be sent may be created using the current MSS (step 10), which originally is designated MSS(i). The TCP layer may use the generated DDP segment as a payload for the TCP segments (step 11). Data including the TCP segments may then be transmitted (step 12).

If the MSS has changed, then the MSS is modified to the new MSS, designated MSS(i+1) (step 14). In the prior art, the transmit operation continues with the new MSS. At the moment of MSS change, the TCP may have a TCP stream consisting of DDP segments generated with the previous MSS (that is, MSS(i)). However, now that the MSS has changed, the transmit may include segments that are segmented using the new MSS(i+1). This means that the DDP segments are not aligned, which may cause problems during the retransmit operation.

If the data is acknowledged, no retransmit is necessary and the data flow continues as required. If the data is not acknowledged, then retransmit starts (step 13). As just described for transmit, if the MSS has changed, the DDP segments may not be aligned for the retransmit procedure.

The generic RNIC transmitter that handles the TCP transmission must account for all the different DDP segments until the retransmit has been completed. At first, the DDP segments have been created with MSS(i). However, after the first MSS change, the RNIC must handle additional DDP segments created with MSS(i+1). After the second MSS change, the RNIC must handle further DDP segments created with MSS(i+2), and so forth. If there are multiple MSS changes, the generic RNIC transmitter may have many outstanding DDP segments of different sizes, since they were segmented using different MSSs. To handle this situation, the RNIC would have to keep a trace of outstanding DDP segments and the MSS that was used for their segmentation, or would need to keep outstanding segments themselves, as a retransmit buffer. In any case, this would consume significant memory resources on the RNIC and hamper communication over high-speed links.

### SUMMARY OF THE INVENTION

The present invention seeks to provide improved methods for handling MSS changes in the RDMA protocol, as is described more in detail hereinbelow.

In accordance with an embodiment of the present invention, if the MSS has changed, the transmit operation (DDP segmentation) is temporarily halted until all outstanding data has been completed, that is, acknowledged. In this manner, even if there are multiple MSS changes, there is no need to keep the history of the MSS changes and their boundaries in order to preserve the same DDP segmentation for the retransmit operation, as is described more in detail hereinbelow.

### BRIEF DESCRIPTION OF THE DRAWINGS

The present invention will be understood and appreciated more fully from the following detailed description taken in conjunction with the appended drawings in which:

FIG. 1 is a simplified flow chart illustration of DDP segmentation and TCP transmission in the prior art with changes in the MSS;

FIGS. 2A and 2B together are a simplified flow chart illustration of DDP segmentation and TCP transmission with changes in the MSS, in accordance with an embodiment of the present invention; and

FIG. 3 is a simplified illustration of a system for performing RDMA, in accordance with an embodiment of the present invention.

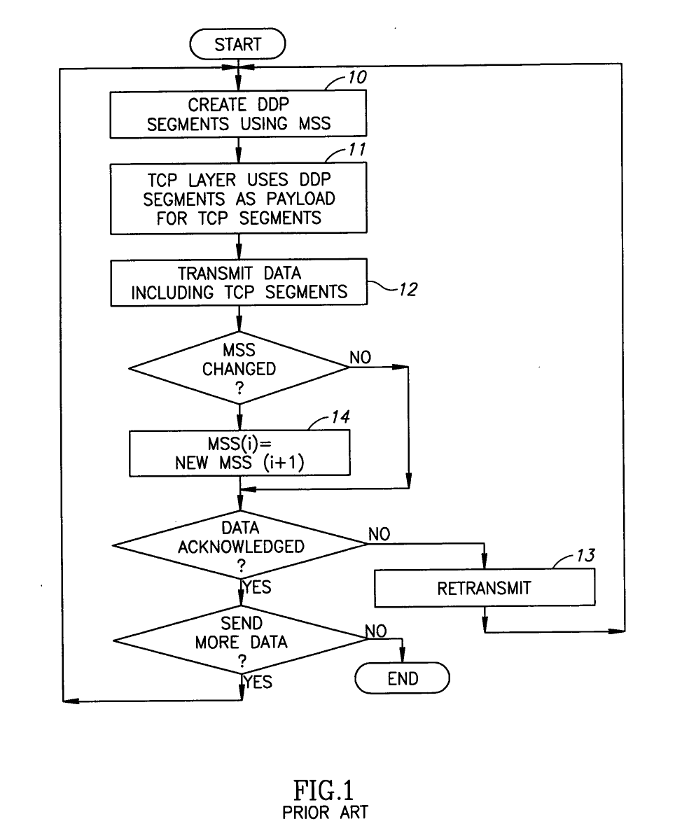

### DETAILED DESCRIPTION OF EMBODIMENTS

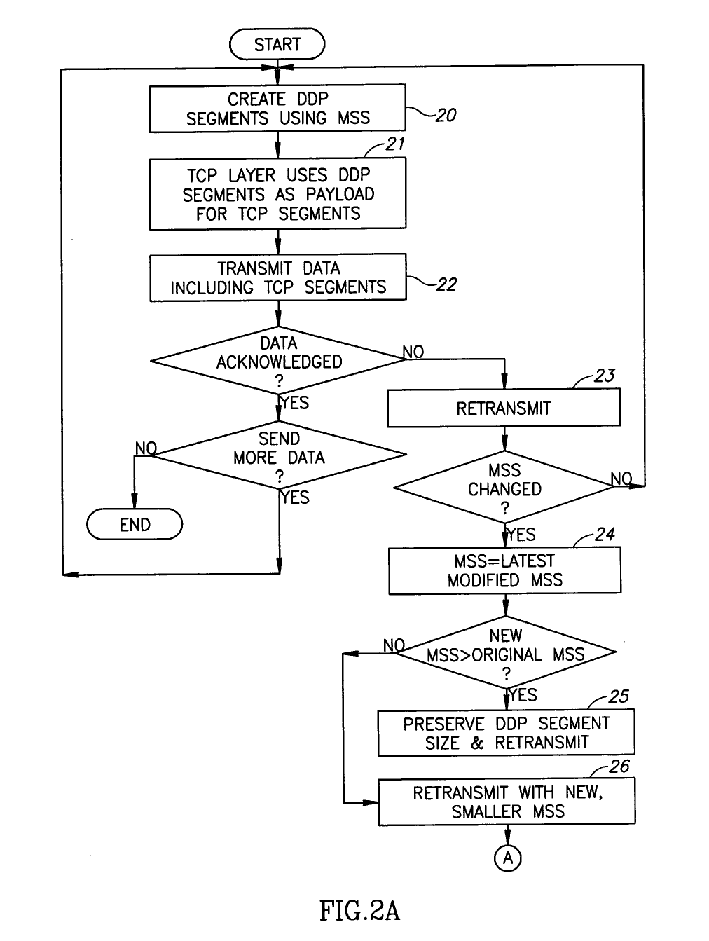

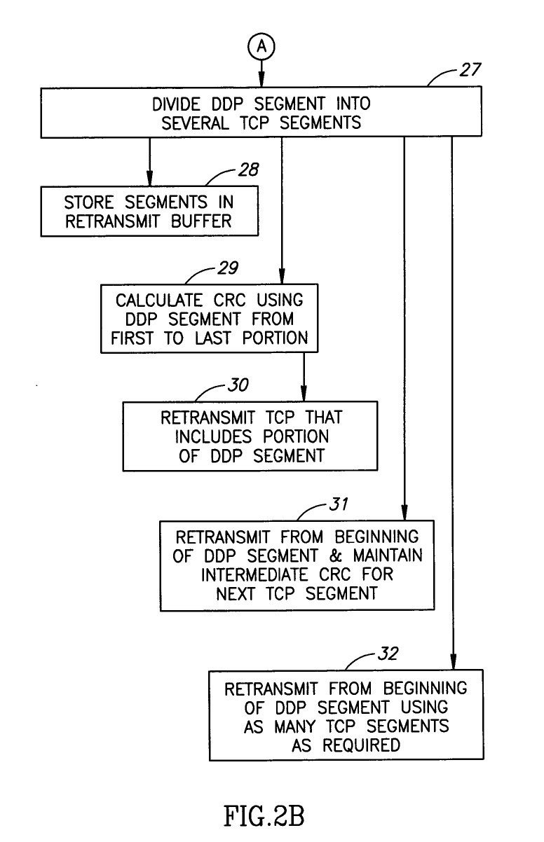

Reference is now made to FIGS. 2A and 2B, which illustrate a non-limiting example of DDP segmentation and TCP transmission with changes in the MSS, in accordance with an embodiment of the present invention. It is noted that the “steps” of the method may be embodied in modules of an RDMA protocol system or in instructions carried out by a computer program product.

The procedure may start similarly to that described above. DDP segments of data to be sent may be created using the current MSS (step or module 20), which originally is designated MSS(i). The TCP layer may use the generated DDP segment as a payload for the TCP segments (step 21). The TCP segments may then be transmitted (step or transmitter 22). If the data is acknowledged, no retransmit is necessary and the data flow continues as required. If the data is not acknowledged, then retransmit starts (step 23, which may be carried out by the transmitter), and the invention ensures having the same segmentation as during transmit, as is now explained.

If the MSS has not changed, then the same DDP segmentation (step 20) may be used to retransmit the data as in step 22.

In accordance with an embodiment of the present invention, if the MSS has changed, the transmit operation is temporarily halted until all outstanding data has been completed. In this manner, even if there are multiple MSS changes, there is no need to keep the history of the MSS changes and their boundaries in order to preserve the same DDP segmentation for the retransmit operation. Since the transmit operation is halted upon MSS change, all transmitted data (which may include incomplete data) have been generated using the same previous MSS. Multiple MSS changes in this case can be accumulated, and the latest modified MSS can be used to perform the retransmit operation, if necessary (step 24). Using the latest modified MSS means that the retransmit process is not sensitive to multiple sequential MSS changes.

If the MSS changes, the new MSS may be less or greater than the original MSS.

If the new MSS is greater than the original MSS, then the size of the DDP segments used for the original transmit may be used to retransmit the segments. The transmitter may retransmit the TCP segments with the latest modified MSS or with a size smaller than the new MSS (step 25).

If the new MSS is less than the original MSS, then the transmitter may retransmit the TCP segments using the new, smaller MSS (step 26). Since the original DDP segmentation is maintained, a single DDP segment may be divided into several TCP segments (step 27). In this case the last segment may be smaller than a full MSS.

In the RDMA protocol, the last portion of the DDP segment carries the CRC covering the whole DDP segment. Accordingly, if DDP segments were divided into several TCP segments, a retransmit buffer may be used to temporarily store the segments until the CRC is transmitted (step 28). However, this would be disadvantageous due to the possibly significant memory resources that would be necessary.

Instead, various techniques may be used to obviate the need for such a retransmit buffer.

For example, the CRC may be calculated using the TCP segment, newly segmented with the latest modified MSS, which may include the entire DDP segment, from its first portion to its last portion (step 29). Then only the required TCP segment that includes a part of the DDP segment (not necessarily from the beginning of the DDP segment, but including the CRC) may be retransmitted (step 30).

As another example, the retransmit procedure may start from the beginning of the DDP segment (regardless of which sequence number to retransmit from), and the intermediate CRC may be maintained in the connection context to be used by the next TCP segment to retransmit (step 31).

As yet another example, the retransmit procedure may start from the beginning of the DDP segment, and the whole DDP segment may be retransmitted using as many TCP segments as needed (step 32).

In summary, each of the exemplary options (steps 29-32) enables retransmitting the entire DDP segment or a portion thereof, when the new MSS is smaller than the one used for DDP segmentation during transmit.

Temporary suspension of the transmit operation upon MSS change may significantly simplify RNIC transmitter implementation. The generic RNIC transmitter that handles the TCP transmission may simply handle one segmentation (carried out with the original MSS) until the retransmit has been completed, as opposed to the cumbersome method of the prior art, without any regard for the number of MSS changes and without consuming additional resources.

Slight performance degradation may perhaps be detected at the moment of MSS change (due to suspending transmit), but assuming that MSS change is a relatively rare event, this does not affect overall system performance.

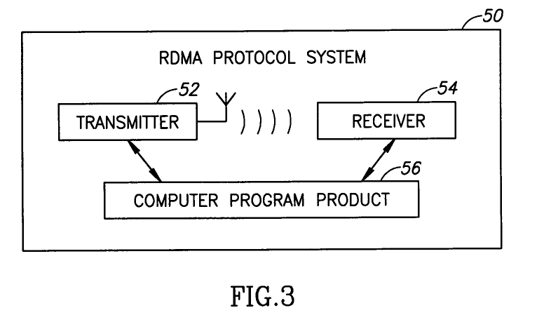

As mentioned above, the method of the invention may be embodied in modules of an RDMA protocol system or in instructions carried out by a computer program product. Referring to FIG. 3, an RDMA protocol system 50 may be provided, including, among other things, one or more transmitters 52 for TCP transmitting data to one or more receivers 54, wherein as described above, if the original MSS has changed to a new MSS, transmitter 52 may temporarily halt DDP segmentation until outstanding data has been acknowledged. A computer program product 56, such as but not limited to, a Network Interface Card (NIC), Host Bus Adapter (HBA), a floppy disk, hard disk, optical disk, memory device and the like, may include instructions for carrying out the methods described hereinabove.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for performing Remote Direct Memory Access (RDMA), the method comprising:
creating Direct Data Placement (DDP) segments of data using a Maximum Segment Size (MSS), called the original MSS;
using the DDP segments as a payload for TCP (Transport Control Protocol) segments;
TCP transmitting data including said TCP segments; and
if the original MSS has changed to a new MSS, temporarily halting DDP segmentation until outstanding data has been acknowledged.

2. The method according to claim 1, wherein if retransmit of said data is required, carrying out a TCP retransmit of said data, which includes the DDP segments segmented using the original MSS, while temporarily halting DDP segmentation.

3. The method according to claim 1, wherein if the MSS has been modified to more than one new MSS, a TCP retransmit of said data is carried out using the latest modified MSS.

4. The method according to claim 1, wherein if the new MSS is greater than the original MSS, then the size of the DDP segments that had been used to TCP transmit the data is preserved for a retransmit.

5. The method according to claim 1, further comprising retransmitting the data including the TCP segments with a size smaller than the new MSS.

6. The method according to claim 1, wherein if the new MSS is less than the original MSS, then further comprising retransmitting the TCP segments using the new MSS.

7. The method according to claim 6, further comprising dividing a single DDP segment into several TCP segments.

8. The method according to claim 7, wherein a last portion of one of the DDP segments carries a check value, called a cyclic redundancy check (CRC).

9. The method according to claim 8, further comprising storing TCP segments in a retransmit buffer until the CRC is transmitted.

10. The method according to claim 8, further comprising calculating the CRC using the TCP segment, newly segmented with the latest modified MSS and including the entire DDP segment, from its first portion to its last portion, and then retransmitting the TCP segment that includes a part of the DDP segment that includes the CRC.

11. The method according to claim 8, further comprising starting the retransmit from the beginning of the DDP segment, and maintaining an intermediate CRC to be used by the next TCP segment to retransmit.

12. The method according to claim 8, further comprising starting the retransmit from the beginning of the DDP segment, and retransmitting the whole DDP segment using as many TCP segments as needed.

13. A computer program product for use with a system that performs RDMA, wherein the system creates DDP segments of data using a MSS, called the original MSS, uses the DDP segments as a payload for TCP segments, and TCP transmits data including the TCP segments, the computer program product comprising:
instructions for temporarily halting DDP segmentation until outstanding data has been acknowledged, if the original MSS has changed to a new MSS.

14. The computer program product according to claim 13, further comprising instructions to carry out a TCP retransmit of said data, which includes the DDP segments segmented using the original MSS, while temporarily halting DDP segmentation.

15. The computer program product according to claim 13, wherein if the new MSS is greater than the original MSS, then the instructions comprise instructions to retransmit while preserving the size of the DDP segments that had been used to TCP transmit the data.

16. The computer program product according to claim 13, wherein if the new MSS is less than the original MSS, then the instructions comprise instructions to retransmit the TCP segments using the new MSS.

17. A system for performing RDMA, the system comprising:
a transmitter for TCP transmitting data including TCP segments that include DDP segments of data created using a MSS, called the original MSS, wherein if the original MSS has changed to a new MSS, the transmitter is adapted to temporarily halt DDP segmentation until outstanding data has been acknowledged.

18. The system according to claim 17, wherein if retransmit of said data is required, the transmitter is adapted to carry out a TCP retransmit of said data, which includes the DDP segments segmented using the original MSS, while temporarily halting DDP segmentation.

19. The system according to claim 17, wherein if the new MSS is greater than the original MSS, then the transmitter is adapted to retransmit while preserving the size of the DDP segments that had been used to TCP transmit the data.

20. The system according to claim 17, wherein if the new MSS is less than the original MSS, then the transmitter is adapted to retransmit the TCP segments using the new MSS.
